(19) United States
(12) Patent Application Publication
(10) Pub. No.: US 2006/0182292 A1
(43) Pub. Date: Aug. 17, 2006

(54) Panel- shaped acoustic wave generator

(75) Inventors: Ronaldus Maria Aarts, Eindhoven (NL); Martinus Hermanus Wilhelmus Maria Van Delden, Eindhoven (NL); Mark Thomas Johnson, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/564,329

(22) PCT Filed: Jul. 8, 2004
(86) PCT No.: PCT/IB04/51163

§ 371 Date: Jan. 10, 2006

(30) Foreign Application Priority Data
Jul. 16, 2003 (EP) 03102184.3

(51) Int. Cl. H04R 25/00

(52) U.S. Cl. 381/152

(57) ABSTRACT

A panel-shaped acoustic wave generator (1A; 1B; 101) comprises one or more planar plates (2,3;102,103). In an embodiment two planar plates (2, 3; 102, 103) are arranged substantially parallel at a distance (D) from each other, while the wave generator (1A;1B;101) further includes an acoustic transducer unit (4; 110A) for causing at least one of the plates to vibrate and a motional feedback unit (10; 110B). The motional feedback unit (10; 110B) comprise an integrated motion sensor (9) which comprises a first sensor component (11; 111B) mechanically coupled to a first plate (2; 102) and a second sensor component (12; 112B) mechanically coupled to a second plate (3; 103). In a specific embodiment, the wave generator is implemented as a display device (100) wherein the feedback means comprise at least one display cell (110B) of the display device.

### FIELD OF THE INVENTION

The present invention relates in general to a panel-shaped acoustic wave generator. Particularly, the present invention relates to an image display device, of a type useable for electronic devices such as mobile telephones, computers, televisions, etc., which is provided with acoustic transducer means such that the display device itself can fulfil the function of a loudspeaker so that a separate loudspeaker can be omitted. However, the present invention is not restricted to such devices; ornamental panels are also envisaged.

### BACKGROUND OF THE INVENTION

Panel-shaped acoustic wave generators are known per se. They comprise at least one planar plate, and acoustic transducer means capable of causing said plate to vibrate. Such device can be designed as a panel-shaped loudspeaker, as disclosed for example in U.S. Pat. No. 6,198,831.

It is also possible that an image display device, such as for instance an LCD in a laptop computer, is used as panel-shaped acoustic wave generator such that it can fulfil the function of a loudspeaker, as disclosed for instance in U.S. Pat. No. 5,828,768, in which case the acoustic transducer means are external to the panel, and comprise a piezo element attached to one of the plates of the panel.

WO02/082858 discloses an image display device with integrated acoustic transducer means. This document, which is incorporated herein by reference, gives an elaborate list of specific types of image display devices. As explained in said document, a display device comprises two planar plates arranged substantially parallel at a distance from each other, and an array of display cells, each display cell comprising a first electrode connected to a front plate and a second electrode connected to a back plate with a dielectric medium arranged between said two electrodes. When an electrical voltage is applied to said electrodes, these electrodes exert a mutual electrostatic force to each other. When this electrical voltage is an alternating voltage, the front plate and back plate of the panel display device are caused to vibrate. For causing vibrations in the acoustical range (about 20 Hz-20 kHz), the required drive frequencies are much lower than the signal frequencies required for displaying an image.

Generally, in a sound reproduction system, it is desirable to have a feedback functionality. An acoustic driver receives an input signal representing the sound to be generated, and generates a drive signal for driving the acoustic transducer means. Feedback means generate a feedback signal indicating the performance of the wave generator, which feedback signal is fed back to the acoustic driver. The acoustic driver compares the feedback signal with an expected performance, and adjusts the drive signal accordingly.

The system described in U.S. Pat. No. 5,828,768 comprises such feedback functionality. In this case, the feedback means which generate the feedback signal comprise a separate microphone which picks up the sound produced by the wave generator. Such implementation is disadvantageous.

One disadvantage is the fact that the delay of a microphone-based feedback signal is relatively large.

Another disadvantage is the fact that the microphone is an additional component, requiring space. Especially in small-sized electronic apparatus, such as for instance a mobile telephone, it is desirable to reduce the number of components as much as possible.

A further disadvantage is the fact that microphones may also pick up undesired acoustical signals (e.g. noise etc.).

### SUMMARY OF THE INVENTION

It is a general objective of the present invention to eliminate or at least reduce the above disadvantages. The invention is defined by the independent claims. The dependent claims define advantageous embodiments.

According to an important aspect of the present invention, the wave generator comprises at least one plate, and feedback means which comprise a motion sensor having at least one sensor component mechanically coupled to said plate. Thus, a separate microphone may be omitted. The feedback means are capable of directly measuring the motion of the vibrating plate.

According to a further important aspect of the present invention, the wave generator comprises at least two plates arranged substantially parallel at a distance from each other, and the feedback means comprise a capacitive motion sensor, comprising a first electrode connected to one plate and a second electrode connected to a second plate. When the plates vibrate with respect to each other, an electrical signal is developed over said electrodes.

In a special embodiment of the present invention, the two plates are part of a display device, such as for instance an LCD, which comprises an array of display cells, each cell comprising a front electrode and a back electrode, wherein the feedback means comprise at least one of the display cells of the display device. This special embodiment of the present invention is based on the insight that a planar display device comprises cells which can be used as integrated capacitive motion sensors. In this respect, the insight of the present invention differs from the insight of the invention in WO02/08285, in which case the insight is that an electrical signal results in a mechanical force.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A is a schematic cross-section of a first embodiment of a panel-shaped acoustic wave generator according to the present invention;

FIG. 1B is a schematic cross-section of a second embodiment of a panel-shaped acoustic wave generator according to the present invention;

FIG. 2 is a schematic cross-section of a preferred embodiment of a panel-shaped acoustic wave generator according to the present invention, implemented in a display panel;

FIG. 3 is a block diagram schematically illustrating a feedback function of the wave generator, and

FIG. 4 is a schematic front view of a display in which the wave generator of the present invention is implemented.

### DESCRIPTION OF THE INVENTION

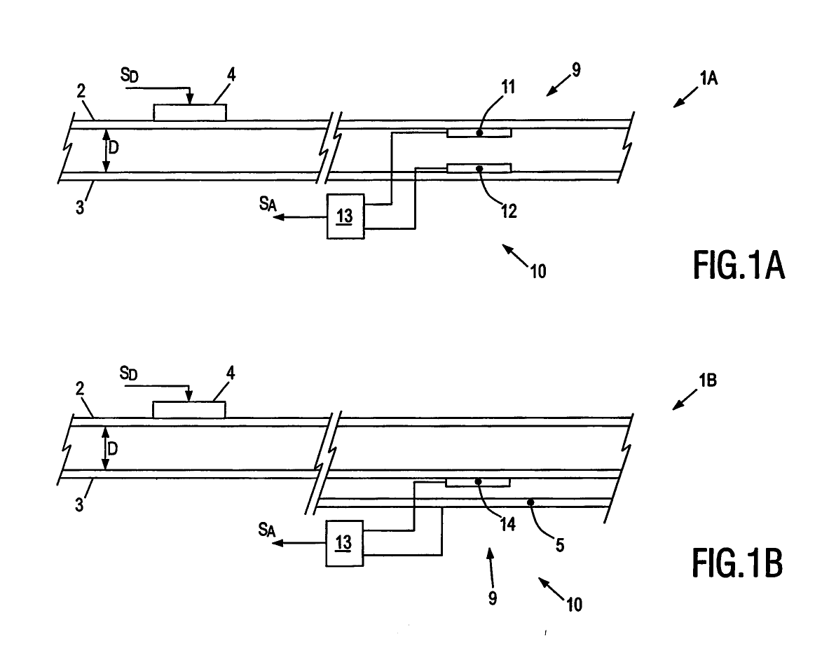

FIG. 1A is a schematic cross-section of a first embodiment of a panel-shaped acoustic wave generator 1A according to the present invention. The wave generator 1A comprises a first planar plate 2 and a second planar plate 3 arranged substantially parallel at a small distance D from each other. Mounting and separation means for holding the plates at the desired distance are not shown for sake of simplicity. The wave generator 1A further comprises an acoustic transducer 4, for instance a piezo-element, attached to the first plate 2. When the transducer 4 receives a drive signal S_{D}, it exerts mechanical forces on the first plate 2, causing at least the first plate 2 to vibrate.

The wave generator 1A further comprises feedback means 10, comprising an integrated motion sensor 9 having a first electrode 11 and a second electrode 12 attached to the plates 2 and 3, respectively, on the plate surfaces facing each other. These plate surfaces will hereinafter be indicated as inner surfaces. The respective opposite surfaces will hereinafter be indicated as outer surfaces.

In the example shown, the electrodes 11, 12 are arranged at a location differing from the location of the transducer 4, but this is not necessary.

The feedback means 10 further comprise a signal generator 13, having inputs electrically coupled to the electrodes 11 and 12, and having an output generating a signal S_{A} which relates to the mutual distance of the electrodes 11 and 12 with respect to each other, and therefore the distance of the plates 2 and 3 with respect to each other, or at least the plate segments where the electrodes are located.

The electrodes 11, 12 are capacitively coupled to each other, and together they form a capacitive sensor 9, which is sensitive to displacement of the electrodes 11, 12 with respect to each other. This displacement can be translated into an electrical signal and processed by the signal generator 13 in a manner known per se. For instance, when the electrodes 11, 12 are held at a constant voltage difference, relative movement of the electrodes in a direction perpendicular to the surface of the plates 2, 3 will cause an electric current. It is noted that capacitive motion sensors are known per se, therefore a more detailed explanation of capacitive motion sensors is omitted here.

It is noted that the sensor 9 is sensitive to motion of the electrodes 11, 12 with respect to each other, and the sensor signal contains information regarding mutual speed and mutual acceleration of the electrodes 11, 12 with respect to each other (i.e. first and second time derivatives of mutual distance). The signal generator 13 may be designed to selectively generate its output signal such as to only contain speed information or to only contain acceleration information, or both.

It is noted that the electrodes 11, 12 should be electrically insulated from each other. In case the plates 2, 3 are made from a non-conductive material, this requirement is met. In case the plates 2, 3 are made from an electrically conductive material, insulating means should be arranged between the electrodes and the plates 2, 3, respectively. It is further noted that the plates 2, 3 preferably are of equal size, but the plates 2, 3 may have different sizes.

FIG. 1B is a cross-section comparable to FIG. 1A, illustrating a second embodiment of a planar-shaped acoustical wave generator 1B, which is similar to the first wave generator 1A, except for the implementation of the motion sensor 9, which in this case comprises an electrode 14 mounted at the outer surface of the second plate 3, and a third plate arranged at a small distance from the second plate 3, substantially parallel thereto. In the embodiment illustrated, the third plate 5 itself is electrically conductive and acts as an electrode. Alternatively, the third plate may carry a separate electrode, but this is not illustrated.

It is noted that the third plate 5 may be replaced by any suitable reference object, suitably arranged for cooperation with the said electrode 14. It is further noted that the wave generator does not necessarily need to have two plates: in the case of a separate reference object 5, it is sufficient for the wave generator to have only one plate 3, in which case the transducer 4 should be arranged to engage this one plate 3.

In the embodiment shown, the third plate 5 is larger than the electrode 14, but this is not necessary. Also, it is not necessary that the electrode 14 is mounted on the outer surface of the second plate 3; alternatively, the electrode 14 may be arranged on the outer surface of the first plate 2, i.e. the same surface as where the transducer 4 is arranged. This is even preferred in cases where the mechanical coupling between the first and second plates 2, 3 is weak, so that the vibration of the first plate 2 as caused by the transducer 4 is not transferred to the second plate 3, or not sufficiently, so that the vibration of the second plate 3 would not be a good source for feedback signals.

In the embodiments of FIGS. 1A and 1B, the plates may in principle have any design. In a particularly preferred embodiment, the plates 2, 3 are the back plate and the front plate, respectively, of a display device comprising an array of display cells, each display cell comprising a first electrode connected to said front plate and a second electrode connected to said back plate with a dielectric medium arranged between said two electrodes. In such embodiment, the electrodes 11 and 12 comprise the cell electrodes of at least one display cell of the display device.

Display devices are known per se, so it is not necessary here to give a detailed explanation of the design and operation of display devices. WO02/082858, incorporated herein by reference, gives a list of different types of display devices, all of which have display cells having cell electrodes arranged on opposing surfaces of substrate plates, all of these types of display devices being useable in the wave generator according to the present invention.

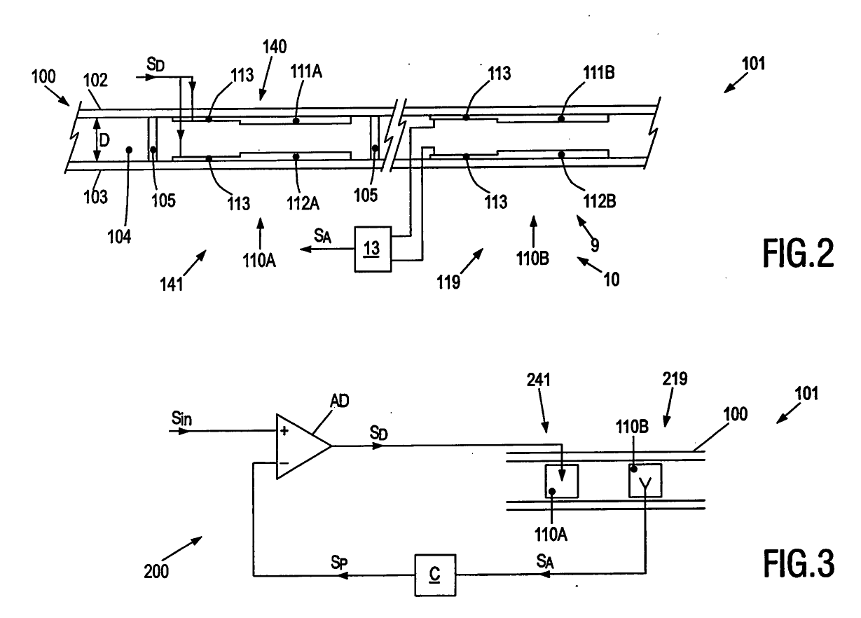

FIG. 2 is a cross-section, comparable to FIG. 1A, of a preferred embodiment of a panel-shaped acoustic wave generator 101, implemented in a display device 100 comprising a back plate 102 and a front plate 103 of a suitable material, for instance a stiff material such as glass or the like, arranged substantially parallel to each other at a small mutual distance D. A dielectric material 104 is arranged between the plates 102 and 103. This dielectric material 104 may be any suitable material, including air. In an exemplary embodiment, the display device 100 may be an LCD, in which case the dielectric material 104 comprises a liquid crystal. The display device 100 comprises a plurality of display cells 110, each display cell 110 comprising a pair of electrodes 111, 112 arranged on the inner surfaces of the plates 102, 103, respectively. Each electrode is made from a transparent conductive film. Two or more of the electrodes 111 or 112 of different cells 110 may be combined to define one common electrode, but this is not shown in the figure. Conductive tracks for addressing the individual cells 110, also made from a transparent conductive film, are schematically indicated at 113. Each cell 110 may be provided with associated switching means, for instance a thin film transistor, but this is not shown in the figure for sake of simplicity.

It is noted that display devices are known per se; therefore, a more detailed description of design and operation of different types of display devices is omitted here. In FIG. 2, two of such display cells are shown, mutually distinguished by the addition of an index A or B to the corresponding reference numerals. All display cells may be used to implement a display function, but this is not illustrated in the figure. It is noted, however, that it is not necessary that all display cells are actually used for their optical display functionality, and it is even possible that none of the display cells is optically active; in that case, the display acts as loudspeaker.

The preferred wave generator 101 of FIG. 2 comprises an integrated acoustic transducer 140, which comprises a first group 141 of display cells 110. The cells 110 belonging to this first group 141 will hereinafter also be indicated as transducer cells 110A. An electrical drive signal S_{D} is applied to the transducer cells 110A. All transducer cells 110A may receive the same drive signal S_{D}, but it is also possible that the transducer cells 110A are organized into subgroups, the cells within each subgroup receiving the same drive signal but the cells in different subgroups receiving different drive signals, in order to obtain certain desired acoustic properties like convergence or direction of sound beam. It is noted that the use of display cells as acoustic transducer is known per se; reference is made to WO02/082858 in this respect. Therefore, this aspect will not be explained in further detail here.

The preferred wave generator 101 of FIG. 2 further comprises an integrated motion sensor 9, which comprises a second group 119 of display cells 110. The cells 110 belonging to this second group 119 will hereinafter also be indicated as sensor cells 110B. The motion sensor 9 is part of feedback means 10 for generating a feedback signal S_{A} representing the relative motion of the cell electrodes 111B, 112B with respect to each other, similarly as described with reference to FIGS. 1A and 1B. It is noted that there may be display cells 110 which are neither used as transducer cell nor as sensor cell; however, in a particular embodiment all display cells are used either as transducer cell or as sensor cell, so that the first group 141 of the transducer cells 110A and the second group 119 of the sensor cells 110B are complementary to each other.

FIG. 3 is a block diagram schematically illustrating an electronic apparatus 200, such as a sound reproduction system, comprising a planar wave generator 101 according to the present invention. The figure schematically shows a part of a display 100 having at least one subgroup 241 of transducer cells 110A and at least one subgroup 219 of sensor cells 110B. A controller C receives the feedback signal S_{A} from the sensor cells 110B, and calculates a prediction signal S_{P}. An acoustic driver AD, for instance implemented as a difference amplifier, for instance an opamp, has a signal input receiving an input signal S_{IN} and a feedback input receiving the prediction signal S_{P} from the controller C. The acoustic driver AD is designed to calculate the difference between the input signal S_{IN} and the prediction signal S_{P}, which difference is used as drive signal S_{D} to drive the transducer cells 110A.

If required, for instance in case the output signal S_{A} from the sensor cells 110B is not a good enough representation of the movement of the corresponding area of the plates 102, 103, for instance due to the complicated vibration patterns of the panel, the controller C may be provided with a lookup table (not shown) or the like for correcting the prediction signal S_{P}.

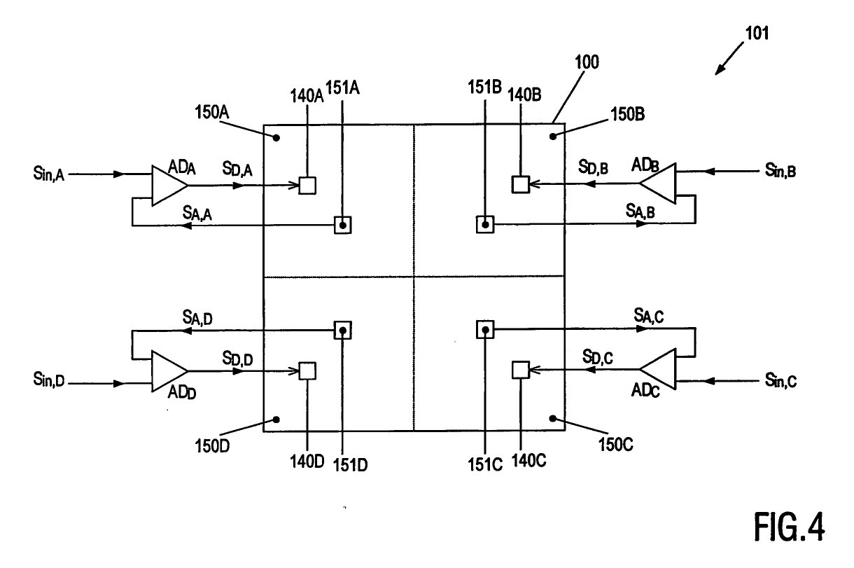

FIG. 4 is a schematic front view of the display 100 to illustrate a preferred embodiment of the wave generator 101 of the present invention. In this preferred embodiment, the display 100 is partitioned into a plurality of display sections 150. In the example of FIG. 4, the number of display sections is equal to four, those sections being labelled 150A, 150B, 150C, 150D, respectively. Each display section 150 has an associated acoustical transducer, for instance a piezo element or, preferably, an integrated acoustical transducer 140 comprising a group of transducer cells 110A as explained with reference to FIG. 2. Each display section 150 has a relatively small area 151 in which the display cells 110 are used as sensor cells 110B. This small area 151 will hereinafter be indicated as sensor area. Drive signals are generated for each display section 150 individually by the respective acoustic drivers AD_{A} to AD_{D}. In each display section 150A, 150B, 150C, 150D, the sensor areas 151A, 151B, 151C, 151D generate individual section feedback signals S_{A,A}, S_{A,B}, S_{A,C}, S_{A,D}, respectively, in dependence on respective input signals S_{in,A} to S_{in,D} which are used to generate the individual drive signals S_{D,A}, S_{D,B}, S_{D,C}, S_{D,D}, respectively, for the corresponding acoustical transducers 140A, 140B, 140C, 140D, respectively.

In FIG. 4, the input signals S_{IN} for the different display sections 150 are shown as being different; however, these signals may be mutually identical.

It is noted that, in FIG. 4, the integrated acoustical transducers 140 are shown as occupying only a small part of the corresponding display sections 150 for sake of clarity. However, the integrated acoustical transducers 140 may in fact be complementary to the corresponding sensor areas 151.

In a variation, not illustrated for sake of simplicity, each display section 150 may comprise a plurality of sensor cell areas 151 in order to obtain motion information from different positions in the corresponding display section. In operation, the feedback signals from the individual sensor cell areas 151 of a display section 150 may be averaged to obtain a better measure of the motion of the display section 150 as a whole.

As is known to persons skilled in the art, the plates 102 and 103 of display devices 100 are held at a mutual distance by spacers 105 arranged between the plates 102 and 103; these spacers 105 are shown as bars in FIG. 2. In a preferred embodiment, the sensor cell areas 151 have a reduced number of spacers 105, or are even free from such spacers, in order to reduce the stiffness of the sensor cell areas 151.

It should be clear to a person skilled in the art that the present invention is not limited to the exemplary embodiments discussed above, but that several variations and modifications are possible within the protective scope of the invention as defined in the appending claims.

For instance, it is not necessary that the electrodes of the capacitive motion sensor 9 are arranged on plate surfaces directed towards each other, although such is preferred. For instance, with reference to FIG. 1A, electrodes 11 and 12 may be arranged on the outer surfaces of plates 2 and 3. Also, with reference to FIG. 1B, electrode 14 may be arranged on the inner surface of plate 3.

Further, the plates may have any design. Preferably, they are planar, but this is not essential in the context of the present invention. Further, the plates may have equal size and have a rectangular contour, so that the panel-shaped acoustic wave generator has a rectangular contour. However, the plates may have a different contour, such as for instance triangular, or may have curved sides, and may even be circular. Further, the plates may be of a stiff material, like glass or the like, but the plates may also be flexible, like thin plastic, so that the panel-shaped wave generator can be folded or rolled-up.

As mentioned, in a preferred embodiment, the panel-shaped wave generator is integrated in a display device. The display device may be a liquid liquid crystal display device comprising a liquid crystal material, which liquid crystal layer may for instance comprise a flexoelectric liquid crystal material or a cholestic liquid crystal material or a ferroelectric liquid crystal material.

Also, the display device may be an electrochromic display device comprising an electrochromic material arranged between said two plates, said electrochromic material having a property of being capable to switch color in dependence of an electric current or an electric potential.

Also, the display device may be an electrophoretic display device comprising an electrophoretic material arranged between said two plates.

Also, the display device may be a reflective display device comprising an interferometric modulator arranged between said two plates.

Also, the display device may be a luminescent display device comprising a luminescent material arranged between said two plates.

Also, the display device may be an organic display device comprising an organic light-emitting material arranged between said two plates.

Also, the display device may be a field-emission display device.

Also, the display device may be a foil display device.

Also, the display device may be a plasma display device.

Also, the display device may be a plasma-addressed liquid crystal display device.

Advantageously, the wave generator of the present invention is part of an electronic apparatus. Such electronic apparatus may, for instance, be a sound reproduction system, or a mobile telephone, or an image screen, or an ornamental panel, or a loudspeaker device.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Panel-shaped acoustic wave generator comprising:
at least one plate
acoustic transducer means for of causing said plate to vibrate;
feedback means for generating a feedback signal and
comprising a motion sensor having at least one sensor component mechanically coupled to said plate.

2. Wave generator according to claim 1, the at least one plate comprising a first plate and a second plate arranged substantially parallel at a distance from each other;
said motion sensor comprising a first sensor component mechanically coupled to the first plate and a second sensor component mechanically coupled to the second plate.

3. Wave generator according to claim 1, wherein said motion sensor comprises a reference component cooperating with said one sensor component, said reference component preferably being a third plate arranged substantially parallel to said one plate at a distance therefrom.

4. Wave generator according to claim 1, wherein said at least one sensor component is integrated in the corresponding plate.

5. Wave generator according to claim 2, wherein said feedback means are adapted to generate a feedback signal representing a relative motion of at least a portion of the first plate with respect to at least a portion of the second plate.

6. Wave generator according to claim 3, wherein said feedback means are adapted to generate a feedback signal representing a relative motion of at least a portion of said plate with respect to said reference component.

7. Wave generator according to claim 2, wherein said motion sensor is a capacitive sensor.

8. Wave generator according to claim 2, wherein said first and second plates comprise a front plate and a back plate, respectively, of a display device comprising an array of display cells each display cell comprising a first electrode connected to said back plate and a second electrode connected to said front plate with a dielectric medium arranged between said two electrodes;
and wherein said motion sensor is an integrated sensor comprising at least a part of at least one display cell of the display device.

9. Wave generator according to claim 8, wherein said acoustic transducer means are integrated transducer means comprising at least a part of at least one display cell of the display device.

10. Wave generator according to claim 9, wherein said integrated motion sensor comprises a first group of display cells, and wherein said integrated transducer means comprise a second group of display cells said first and second groups differing from each other.

11. Wave generator according to claim 8, wherein the display device comprises a plurality of spacers between the said plates
wherein the density of spacers in a display area corresponding with sensor cells is less than the density of spacers in regions outside said display area.

12. Wave generator according to claim 8, wherein said display device is a liquid crystal display device comprising a liquid crystal layer arranged between said two plates.

13. Wave generator according to claim 1, being subdivided into a plurality of sections each section comprising an associated acoustic transducer means and at least one associated feedback means wherein a drive signal for an acoustic transducer means of a section is generated on the basis of the feedback signal from the corresponding feedback means.

14. Electronic apparatus comprising:
a wave generator according to claim 1;
an acoustic driver comprising:
a signal input for receiving an input signal
a feedback input for receiving a feedback signal from the feedback means
a drive output coupled to an input of the acoustic transducer means
the acoustic driver being adapted to generate at its drive output a corrected drive signal on the basis of the input signal and the feedback signal.

15. Method for generating sound using a panel-shaped acoustic wave generator comprising two plates arranged substantially parallel at a distance from each other;
the method comprising the step of generating a feedback signal representing a relative motion of at least a portion of one of said plates with respect to at least a portion of the other of said plates.

16. Method according to claim 15, wherein said feedback signal is generated using a capacitive motion sensor having sensor components mechanically coupled to said plates.
